(19) United States
(12) Patent Application Publication
(10) Pub. No.: US 2016/0057620 A1
(43) Pub. Date: Feb. 25, 2016

(54) METHOD AND APPARATUS FOR PROTECTING USER DATA

(71) Applicant: Recipero Ltd, Kings Stanley (GB)

(72) Inventors: Les Gray, Kings Stanley (GB); Adrian Portlock, Kings Stanley (GB)

(21) Appl. No.: 14/462,713

(22) Filed: Aug. 19, 2014

(51) Int. Cl. H04W 12/06; H04W 4/00; H04W 12/08

(52) U.S. Cl. CPC H04W 12/06; H04W 12/08; H04W 4/003

(57) ABSTRACT

A method is provided of protecting or controlling access to data associated with a user, the user data being accessible to a plurality of applications operating on one or more devices, each of the plurality of applications being adapted to authenticate the user for access to the user data using a different respective authentication mechanism. The method includes: providing each of the plurality of applications with access to a central protection server arranged to maintain for each of the plurality of applications a status reflecting whether the application is allowed continued access to the user data, separate to any authentication status associated with the different authentication mechanisms; and arranging for each of the applications to query the server at predetermined times to determine whether to allow the application continued access to the user data and to prevent access to the user data if it is determined in the negative.

### FIELD

The present invention relates to a method and apparatus for protecting or controlling access to user data.

### INTRODUCTION

This section provides background information related to the present disclosure which is not necessarily prior art.

It is becoming more and more common for users to download and install applications (or “apps”) on their computers, smartphones, tablets and other computing devices. Increasingly these apps provide access to sensitive information about users' finances, activities, location, behaviors and identity. Once installed it is often the case that apps offer unfettered access to their functionality on the assumption that the device is in the hands of the rightful owner.

As a first example, a user installs a social media app on their iPhone. The user enters their social media account credentials and authenticates with the software provider. From this point on, if the phone is not protected by a PIN number or the PIN number is known to or circumvented by another person, that person has immediate access to the user's social media account. That person can post potentially damaging updates as if they are the user, and that person can continue to do so until the user gets round to altering their credentials. In this age of social media and ‘viral’ transmission of content, such occurrences are potentially threatening to private and business relationships, present or future employment and reputations.

As a second example, financial applications are available that offer access to online bank accounts, insurance policy administration, share dealing and so on. These applications frequently use a similar authentication method described in the first example above, and provide the user with the option to not have to re-authenticate each time the application is launched. Even if the application itself requires a password to start up, sensitive data may be stored locally on the device and this remains readily accessible to anyone in possession of the device, bypassing what authentication may be built into the application.

As a third example, rather than such an application being installed on a local device (whether portable or not), it is also common for such an application to be available remotely via the Internet. Again, authentication to online services can be provided in the form of a combination of a username and password (and/or other ID), and the user is often given the option (via the browser) of storing or caching these credentials locally. Again, this leads to a vulnerability whereby another person could access the user's account without their knowledge or permission.

An application provider generally provides a mechanism online (or via another device with a suitable app installed) to allow users to change the credentials. Whilst this would enable a user to change their credentials if, for example, they suspect those credentials to have been compromised, the present applicant has appreciated that this can be a very cumbersome and time-consuming process, particularly (as is common nowadays) if the user has many apps and many online accounts. Remembering to log into each one and having to change the credentials is both arduous in the first place and troublesome longer term and many new passwords will have to be remembered and these will often be noted temporarily, introducing another security risk where none previously existed.

There is a continuing desire and need for a solution to overcome the above-identified issues.

### SUMMARY

In concordance with the instant disclosure, there is provided a method of protecting or controlling access to data associated with a user, the user data being accessible to a plurality of applications operating on one or more devices, each of the plurality of applications being adapted to authenticate the user for access to the user data using a different respective authentication mechanism, the method comprising: providing each of the plurality of applications with access to a central protection server which is arranged to maintain for each of the plurality of applications a status reflecting whether or not the application is allowed continued access to the user data, separate to any authentication status associated with the different authentication mechanisms; and arranging for each of the applications to query the protection server at predetermined times to determine whether or not to allow the application continued access to the user data and to prevent access to the user data if the determination is in the negative;

The protection server is adapted to perform the steps of: (a) for each application of the plurality of applications, (i) receiving a registration request to register that application with the protection server, (ii) associating that application with a record maintained for the user, and (iii) maintaining a status reflecting whether or not that application is allowed continued access to the user data; (b) receiving a status query from an application of the plurality; (c) determining with reference to the status associated with that application whether or not continued access to the user data is allowed; and (d) sending a response to the application accordingly.

Referring to a selected one of the plurality of applications in isolation, a method is proposed for use by the selected application of protecting or controlling access to data associated with a user, the user data being accessible to a plurality of applications including the selected application, each of the applications being adapted to authenticate the user for access to the user data using a different respective authentication mechanism, the method comprising providing the selected application with access to a central protection server which is arranged to maintain for each of the plurality of applications a status reflecting whether or not the application is allowed continued access to the user data, separate to any authentication status resulting from performance of the different authentication mechanisms, querying the protection server at predetermined times to determine whether or not to allow continued access to the user data, and preventing access to the user data if it is determined in the negative. A processor or collection of processors may be provided on a device to perform such a method, for example under control of a computer program.

The predetermined times may be selected one or more of: when the application is performing authentication with an authentication server, at application start-up, on wake up from sleep, on elevation to a foreground task, and when the user initiates any interaction after some indeterminate period of inaction. This list is not intended to be exhaustive, and other examples will be apparent.

The protection server may be adapted to allow the user to update the application statuses associated with their user record. This can be made more convenient by assigning the applications into groups, so that the status of a plurality of applications in the same group can be updated together. The application can be assigned to a group based on information provided in the registration request, for example which device the application is operating on, to allow a user to switch the status of all applications associated with a particular device (for example if that device is lost or stolen).

The protection server and application may be so adapted by being provided with appropriate computer-readable code or processor-executable instructions, which code or instructions may be embodied on a tangible and non-transitory computer-readable storage medium such as a computer hard drive.

An embodiment of the present invention permits many applications to be registered in their own right on a single asset register and optionally to be related to a specific device also registered. An embodiment of the present invention offers a developer-independent, application-vendor independent, device-independent method for applications to poll the register each time they are run to check whether they have been disabled or whether the device they are running on has been disabled.

With an embodiment of the present invention, the user need only mark an application—or a device (and thereby affecting many applications)—as locked and the application(s) can subsequently decide whether to restrict access, prompt for authentication again or delete all local data depending on the sensitivity of the application data.

This not only provides a single point of contact for the user to lock any or all of their apps and/or devices but also means it is not necessary to alter the credentials of the online applications associated with the apps.

Thus, security is improved, user confidence improved and inconvenience to the user of the consequences of their loss, mitigated.

For instance, referring to the third example described above (online services), a user may register for online share dealing via a website. The website has chosen to offer the benefits of an embodiment of the present invention to its users. Time passes and the user loses their briefcase containing a notepad in which they have written their new share account password. Because the account was registered with an embodiment of the present invention, the user can go to their asset register, login, disable the share account and others if they please. Should someone try to log in to the user's share account, such an attempt will be rejected even though they know the current access credentials.

This will be described in further detail below, but the following is a non-exhaustive list of features which an embodiment of the present invention is able to provide:

1. A method for preventing a software application instance or online account from operating if the rightful user considers the instance or account to be compromised in some way.

2. Method for validating that a registered software application instance or online account should continue to operate.

3. Method for disabling all registered software application instances installed on a given device

4. Method for programmatically registering software application instances or online accounts as on an asset registration database.

5. Method for recording on an asset registration database the relationship between an application instance and a device it is installed upon.

6. Method for detecting that an application instance has been moved to a different device to allow asset registration links to be updated.

The following abbreviations are used herein:

PA—Protected application—an application that has been provided or programmed with functionality embodying the present invention. A PA could be an application that gets installed into a physical device or it may be an online application such as a website that requires authenticated access from its users.

AR—Asset Register—an asset registration database used in an embodiment of the present invention.

ARO—Asset Register Operator—the legal entity responsible for operating the AR.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. The accompanying figures, which are incorporated in and constitute a part of this specification, illustrate several aspects and together with the description serve to explain the principles of the present technology.

FIG. 1 is a schematic illustration of a first stage according to an embodiment of the present invention (obtaining access);

FIG. 2 is a schematic illustration of a second stage according to an embodiment of the present invention (post install authentication with user's AR account);

FIG. 3 is a schematic illustration of a third stage according to an embodiment of the present invention (post install registration of PA instance);

FIG. 4 is a schematic illustration of a fourth stage according to an embodiment of the present invention (normal operation of the PA);

FIG. 5 is a schematic illustration of a fifth stage according to an embodiment of the present invention (blocking of applications or devices); and

FIG. 6 is a schematic illustration of a computer or device in which a method embodying the present invention can be implemented.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding the methods disclosed, the order of the steps presented is exemplary in nature, and thus, the order of the steps can be different in various embodiments. Except where otherwise expressly indicated, all numerical quantities in this description indicating numerical values are to be understood as modified by the word “about” in describing the broadest scope of the technology.

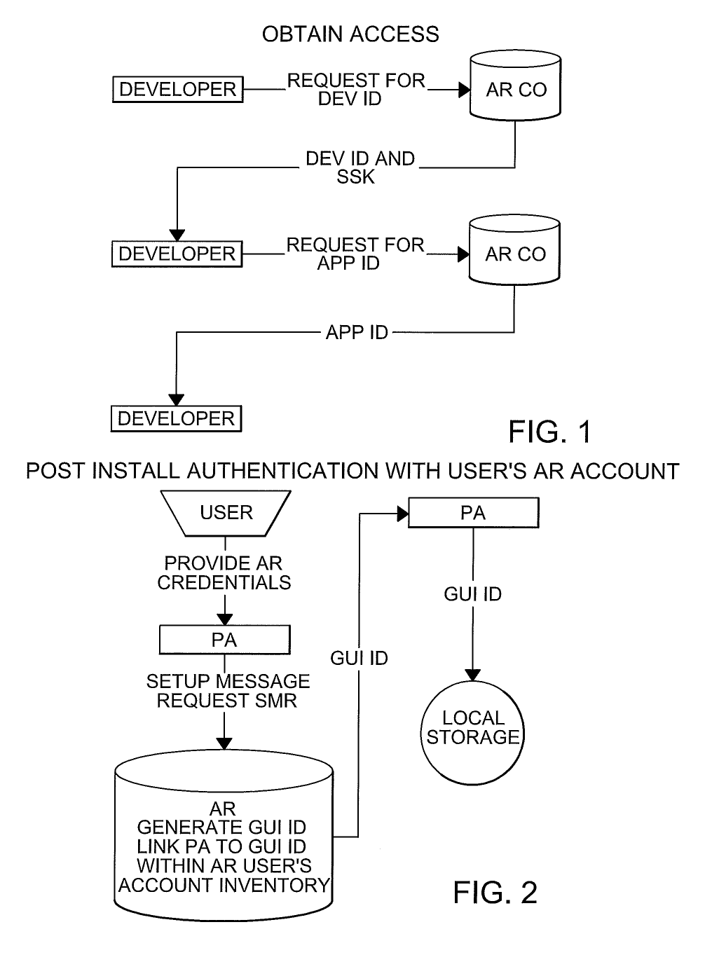

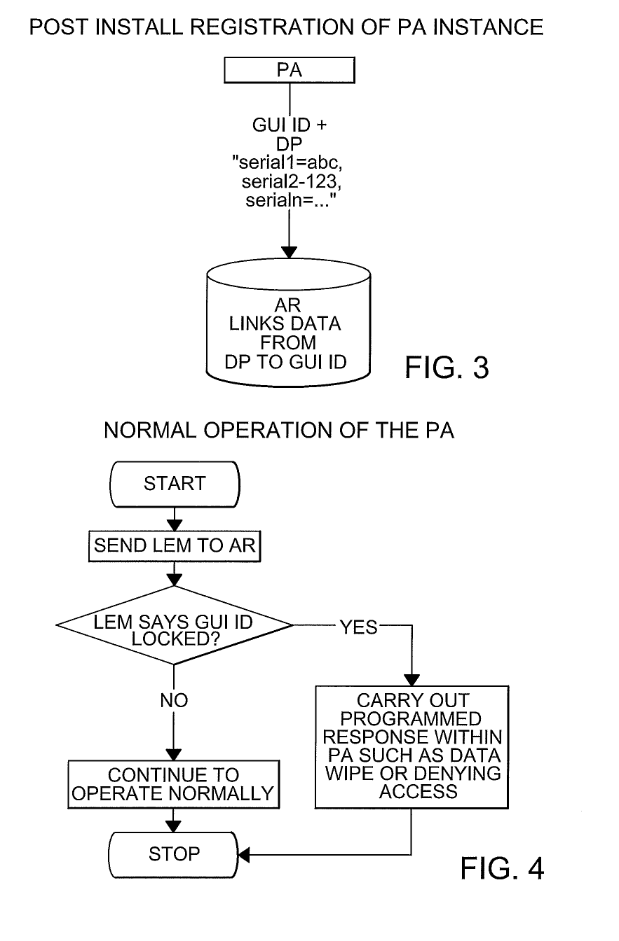

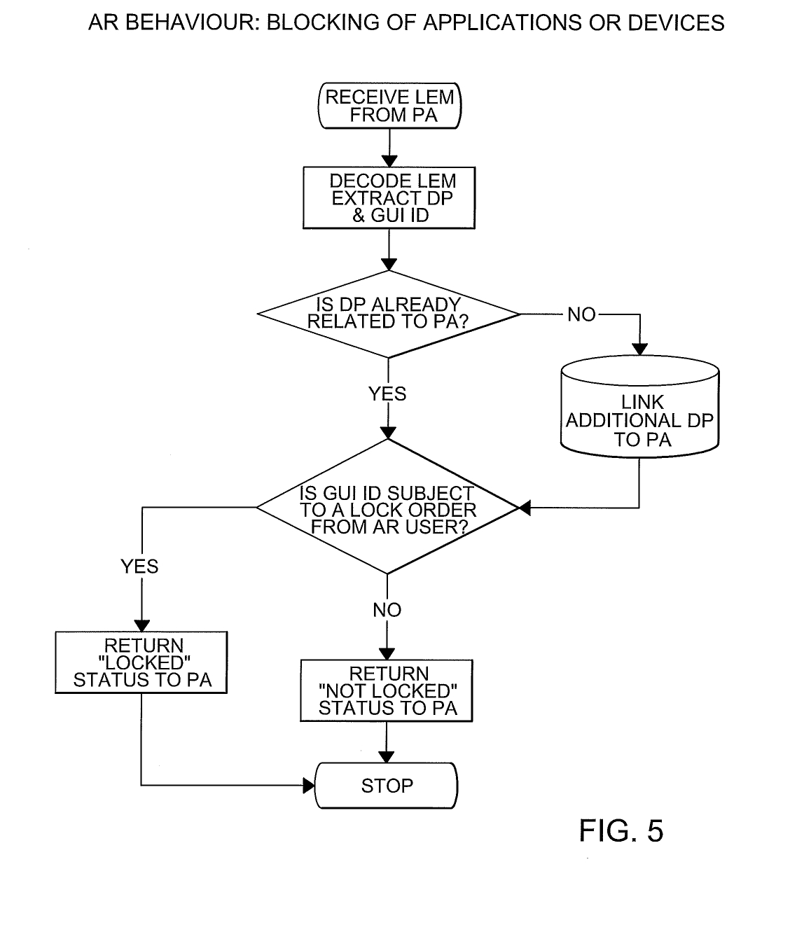

An embodiment of the present invention will now be described with reference to FIGS. 1 to 5, which respectively illustrate five stages. These stages are now described in turn.

Stage 1—Obtain Access

An application developer wishing to produce a protected application first obtains a unique developer identifier (DEVID) from the asset register operator (ARO) and a shared secret key (SSK) that is used for digitally signing requests.

For each software application that the developer wishes to protect, the developer also obtains a unique application identifier (APPID) from the ARO.

These identifiers are compiled into the delivered Protected Application (PA) that will be installed on devices or stored securely for later use if the PA is an online application.

Stage 2—Post Install Authentication with User's AR Account

Upon installation of the PA on a device, the PA seeks permission from the device user to communicate with the user's AR account. If permission is given, the user also provides credentials (different to the user's normal AR credentials and created specifically for this use) that allow the PA to authenticate with the AR. The PA sends a setup message request (SMR) to the AR requesting access.

The AR may accept or reject the authentication. If accepted, the AR now returns a globally unique instance identifier (GUIID) that the PA stores for later use.

At this point, the application instance has been registered against the user's AR account inventory (cf. feature 4 above) and the PA now has the ability to verify if it should continue to run by polling the AR (cf. feature 2 above) at appropriate times as determined by the PA developer.

Henceforth, communications originating from the PA provides the GUIID, one or more parameters depending on the message type, a selected signature scheme and a signature hash generated according to the selected scheme using the SSk as a seed value. The particular signature scheme is not important or central to the operation of an embodiment of the present invention, and therefore need not be described herein.

Stage 3—Post Install Registration of PA Instance

The PA now registers one or more unique device identifiers with the AR. The PA obtains at least one but as many device identifiers as permitted by the device operating system (and the device's privacy settings) and optionally, one or more user provided values. These values can be encoded in any suitable way, such as JSON (JavaScript Object Notation) encoding. The particular encoding method is not important or central to the operation of an embodiment of the present invention, and therefore need not be described herein. The collection of these devices is termed the Device Profile (DP).

The client code then produces a signature hash of a concatenation of the GUIID, DP and SSK. The resulting signature value along with the GUUID and DP form a Device Registration Message (DRM) that is sent to the AR.

At this stage the PA has now created on the AR a record of the link between the PA instance and a physical device (cf. feature 5 above).

When an embodiment of the present invention is used to protect online accounts (such as social media or banking accounts for example), this stage may be ignored by the PA developer.

Stage 4—Normal Operation of the PA

At times (typically during start-up, wake from sleep, elevation to a foreground task, some interaction with the user) determined by the PA developer, the PA will construct a Lock Enquiry Message (“LEM”) and send it to the AR (“Poll The AR”.) The LEM contains the GUUID, the DP and a randomly generated seed value to ensure that this message signature will be unique and a signature hash computed using a supported signature method as referred to in Stage 3.

Upon receipt of the LEM, the AR will query its records for the status of the GUIID and will respond with a result code indicating the presence or absence of a lock request initiated by the AR account holder (cf. feature 2 above).

The presence of the DP in the LEM allows the AR to update its records of the devices that this instance of the PA is linked to (cf. feature 6 above).

In the event of a lock request being present, the PA should take steps to secure access to its resources, online accounts and local data. The precise steps taken will depend on the purpose of the PA, the sensitivity of its data and the wishes of its developer and may include erasing all local data under the PA's control. This behavior is not specified or claimed by the invention and is outside the scope of this documentation.

Stage 5—Blocking of Applications or Devices

The registered AR user first logs into the AR and can then take the following actions.

1. Locate a specific application or a number of applications believed to be compromised (perhaps because of loss, theft or fraud) and mark them as locked. Any future polls (as described in Stage 3) from the PA will be responded to with a lock status and the PA will behave accordingly to prevent its operation. (cf. feature 1 above)

2. Locate a specific device and request that all application instances associated with that device are locked (cf. feature 3 above)

Physical Embodiment

Each of the steps illustrated in the appended drawings can be considered schematically to represent both a function performed by a device and a physical element of that device. One or more of these elements can be provided in the form of one or more processors or processing units, which processing unit or units could be controlled or provided at least in part by a program operating on the device. A single processor or processing unit may be arranged to perform the function of multiple elements. Such an operating program can be stored on a computer-readable medium, or could, for example, be embodied in a signal such as a downloadable data signal provided from an Internet website. Any appended claims now or in future are to be interpreted as covering a computer program by itself, or as a record on a carrier, or as a signal, or in any other form.

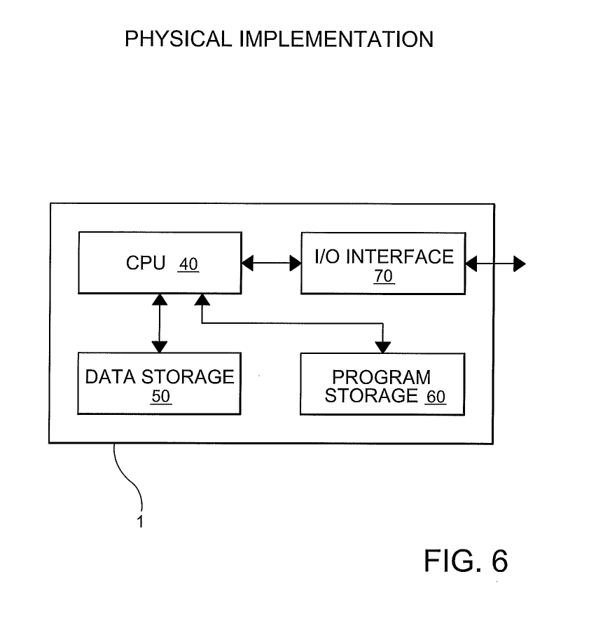

FIG. 6 is a schematic illustration of a computer or device 1 in which a method embodying the present invention can be implemented. A computer program for controlling the device 1 to carry out a method embodying the present invention is stored in a program storage 60. Data used during the performance of a method embodying the present invention is stored in a data storage 50. During performance of a method embodying the present invention, program steps are fetched from the program storage 60 and executed by a Central Processing Unit (CPU) 40, retrieving data as required from the data storage 50. Output information resulting from performance of a method embodying the present invention can be stored back in the data storage 50, or sent to an Input/Output (I/O) interface 70, which may comprise a transmitter for transmitting data to other nodes, as required. Likewise, the Input/Output (I/O) interface 70 may comprise a receiver for receiving data from other devices, for example for use by the CPU 40.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A method of protecting or controlling access to data associated with a user, the user data being accessible to a plurality of applications operating on one or more devices, each of the plurality of applications being configured to authenticate the user for access to the user data using a different respective authentication mechanism, the method comprising the steps of:
providing each of the plurality of applications with access to a central protection server which is arranged to maintain for each of the plurality of applications a status reflecting whether or not the application is allowed continued access to the user data, separate to any authentication status associated with the different authentication mechanisms; and
arranging for each of the applications to query the protection server at predetermined times to determine whether or not to allow the application continued access to the user data and to prevent access to the user data if the determination is in the negative;
wherein the protection server is configured to perform the steps of: (a) for each application of the plurality of applications, (i) receiving a registration request to register that application with the protection server, (ii) associating that application with a record maintained for the user, and (iii) maintaining a status reflecting whether or not that application is allowed continued access to the user data; (b) receiving a status query from an application of the plurality; (c) determining with reference to the status associated with that application whether or not continued access to the user data is allowed; and (d) sending a response to the application accordingly.

2. The method of claim 1, in which each application of the plurality of applications is configured to perform the steps of: querying the protection server at predetermined times to determine whether or not to allow the application continued access to the user data; and preventing access to the user data if the determination is in the negative.

3. The method of claim 1, wherein the predetermined times are selected from one or more of:
when the application is performing authentication with an authentication server, at application start-up, on wake up from sleep, on elevation to a foreground task, and when the user initiates any interaction after some indeterminate period of inaction.

4. The method of claim 2, wherein the predetermined times are selected from one or more of:
when the application is performing authentication with an authentication server, at application start-up, on wake up from sleep, on elevation to a foreground task, and when the user initiates any interaction after some indeterminate period of inaction.

5. The method of claim 3, further comprising allowing the user to update the application statuses associated with their user record.

6. The method of claim 4, further comprising allowing the user to update the application statuses associated with their user record.

7. The method of claim 5, further comprising assigning the applications into groups, so that the status of a plurality of applications in the same group can be updated together.

8. The method of claim 6, further comprising assigning the applications into groups, so that the status of a plurality of applications in the same group can be updated together.

9. The method of claim 7, further comprising assigning the applications into a group based on information provided in the registration requests received for the applications.

10. The method of claim 8, further comprising assigning the applications into a group based on information provided in the registration requests received for the applications.

11. The method of claim 9, in which the applications are assigned into a group based on which device the application is operating on.

12. The method of claim 10, in which the applications are assigned into a group based on which device the application is operating on.

13. An apparatus comprising means configured to perform the method of claim 1.

14. A program for controlling an apparatus to perform the method of claim 1, the program in the form of instructions embodied on a carrier medium such as a storage medium or a transmission medium.

15. A method of protecting or controlling access to data associated with a user, the user data being accessible to a plurality of applications operating on one or more devices, each of the plurality of applications being configured to authenticate the user for access to the user data using a different respective authentication mechanism, the method comprising the steps of:
providing each of the plurality of applications with access to a central protection server which is arranged to maintain for each of the plurality of applications a status reflecting whether or not the application is allowed continued access to the user data, separate to any authentication status associated with the different authentication mechanisms; and
arranging for each of the applications to query the protection server at predetermined times to determine whether or not to allow the application continued access to the user data and to prevent access to the user data if it is determined in the negative.

16. The method of claim 15, further comprising: querying the protection server at predetermined times to determine whether or not to allow the application continued access to the user data; and preventing access to the user data if it is determined in the negative.

17. The method of claim 15, further comprising: (a) for each application of the plurality of applications, (i) receiving a registration request to register that application with the protection server, (ii) associating that application with a record maintained for the user, and (iii) maintaining a status reflecting whether or not that application is allowed continued access to the user data; (b) receiving a status query from an application of the plurality; (c) determining with reference to the status associated with that application whether or not continued access to the user data is allowed; and (d) sending a response to the application accordingly.

18. The method of claim 16, further comprising: (a) for each application of the plurality of applications, (i) receiving a registration request to register that application with the protection server, (ii) associating that application with a record maintained for the user, and (iii) maintaining a status reflecting whether or not that application is allowed continued access to the user data; (b) receiving a status query from an application of the plurality; (c) determining with reference to the status associated with that application whether or not continued access to the user data is allowed; and (d) sending a response to the application accordingly.
